(19) United States
(12) Patent Application Publication
(10) Pub. No.: US 2012/0117852 A1
(43) Pub. Date: May 17, 2012

(54) Repeating Animal Capture and Containment System Having Removable Trapping Devices

(76) Inventor: Benjamin Baker, Chesterland, OH (US)

(21) Appl. No.: 12/946,312

(22) Filed: Nov. 15, 2010

(51) Int. Cl. A01M 23/14; A01M 23/04

(52) U.S. Cl. 43/64; 43/69

(57) ABSTRACT

A repeating animal capture and containment system includes a housing defined by a set of peripheral walls. An opening is formed in one of the peripheral walls and a removable, ramped trapping device is removably mounted within the housing and aligned with the opening in the peripheral wall. The ramped trapping device allows an animal, such as a rodent, to enter into the housing yet prevents the captured animal from exiting the housing. The housing is sized to include a containment area that communicates with the trapping device by a passageway. The containment area provides a living space for the captured animal until it can be set free. The removability of the ramped trapping device allows the device to be removed for cleaning and maintenance as needed. The system further includes features that prevent lateral and/or vertical displacement of the ramped trapping device.

### BACKGROUND OF THE INVENTION

This invention is generally directed to live, repeating animal traps, and more particularly, to an animal trap having a ramped type trapping device.

Repeating live animal traps are well known. These animal traps are commonly used by homeowners and businesses to capture and constrain rodents within an enclosure. The traps are typically outfitted with a disposable glue board to exterminate the captured rodents. These animal traps are also preferred, and many times required, at food manufacturing facilities where the use of poisoned baits is not permitted. Conventional live, repeating animal traps have a housing defining an enlarged enclosure with one or more ramped trap devices that communicate with the interior of the enclosure via an elongated passageway. An inclined plane tilting floor member is positioned in the passageway of each trap device and is adapted to lift a door to block an entrance opening when the rodent passes beyond a pivot point thereby preventing escape from the enclosure. When the rodent exits the passageway into the enclosure, the door falls by gravity or is pulled down by a spring on the entrance end of the tilting floor to reset the trapping device and the raised end of the tilting floor prevent a of captured rodent from returning to the passageway. Disposable glue boards may also be used to prevent a captured rodent from returning to the passageway.

One of the drawbacks of conventional repeating animal traps is that the ramped or inclined plane trapping assemblies are fixed or substantially fixedly attached to the housing. Repeating animal traps, including the ramped trapping assemblies, can be soiled during use and therefore must be cleaned periodically for their continued use to be desirable. Soiling of the assemblies can include dirt and debris, food, excrement from the captured animals, and the carcass of an exterminated animal. Moreover, since many repeating traps are designed to capture and contain multiple animals at one time, it is not uncommon for the traps to become heavily soiled from time to time. For use at food preparation or food handling facilities, there is an increased importance in having clean animal traps. Cleaning of conventional repeating animal traps can be problematic however as their construction typically requires the traps to be transported offsite for cleaning and servicing.

### SUMMARY OF THE INVENTION

The present invention is directed to an animal trap and containment system having a removable ramped trapping assembly. The repeating animal capture and containment system of the present invention includes a housing defined by a set of peripheral walls. An opening is formed in at least one of the peripheral walls and a removable, ramped trapping assembly is removably mounted within the housing and aligned with the opening in the peripheral wall. The ramped trapping assembly allows an animal, such as a rodent, to enter into the housing yet prevents the captured animal from exiting the housing. The housing is sized to include a containment area that communicates with the trapping device by a passageway. The containment area provides a living space for the captured animal until it can be set free. The removability of the ramped trapping assembly allows the device to be more readily cleaned and maintained as needed. The system further includes features that prevent lateral and/or vertical displacement of the ramped trapping device.

In one embodiment, posts extend from a bottom or base panel of the housing and are designed to engage the ramped trapping assembly. When engaged with the ramped trapping assembly, the posts prevent lateral movement of the ramped trapping assembly. In a further embodiment, the ramped trapping assembly includes tabs or feet that slide over the posts when the ramped trapping assembly is loaded into the housing.

In another embodiment, a spring is provided for biasing the ramped trapping assembly against the bottom panel of the housing so as to prevent vertical displacement of the ramped trapping assembly. The spring may be formed on the underside of a cover for the housing or, alternately, may be formed on a top surface of the ramped trapping assembly. It this latter embodiment, the spring may also be used as a handle for lifting and transporting the ramped trapping assembly.

It is also contemplated that lateral and/or vertical displacement of the ramped trapping assembly may be prevented by clips, brackets, and similar structures. Preferably, however, regardless of the structures used to limit movement of the ramped trapping assembly, the ramped trapping assembly can be removed from the housing in a straightforward, relatively easy and, most preferably, tool-free manner.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is an isometric view of an animal trap and containment system according to the present invention;

FIG. 2 is an isometric view of the system of FIG. 1 with a cover of the system in an open position;

FIG. 3 is a section view of the system of FIG. 1 taken along line 3-3 of FIG. 1;

FIG. 4 is a section view of the system of FIG. 1 taken along line 4-4 of FIG. 1;

FIG. 5 is a partial exploded view of the system of FIG. 1;

FIG. 6 is an isometric view of an animal trap and containment system according to another embodiment of the present invention with the cover in an open position;

FIG. 7 is an isometric view of an animal trap and containment system according to yet another embodiment of the present invention with the cover in an open position;

FIG. 8 is an isometric view of an animal trap and containment system according to a further embodiment of the present invention with the cover in an open position;

FIG. 9 is an isometric view of an animal trap and containment system according to another embodiment of the present invention with the cover in an open position;

FIG. 10 is a partial exploded view of the system shown in FIG. 9; and

FIG. 11 is a rear isometric view of a trapping assembly for use with the system shown in FIGS. 9 and 10 according to one embodiment of the invention.

### DETAILED DESCRIPTION OF THE PREFERRED EMBODIMENTS

The present invention will be described with respect to a live animal trap primarily utilized in the trapping of small rodents, such as mice and rats. However, it is understood that the present invention could be applied to other animal traps.

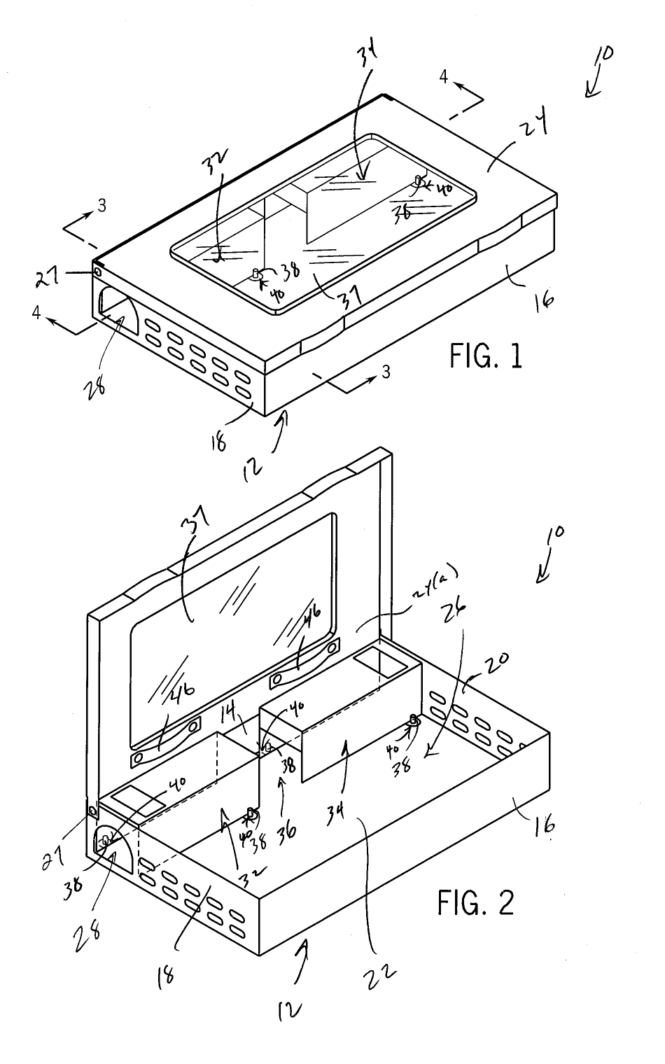

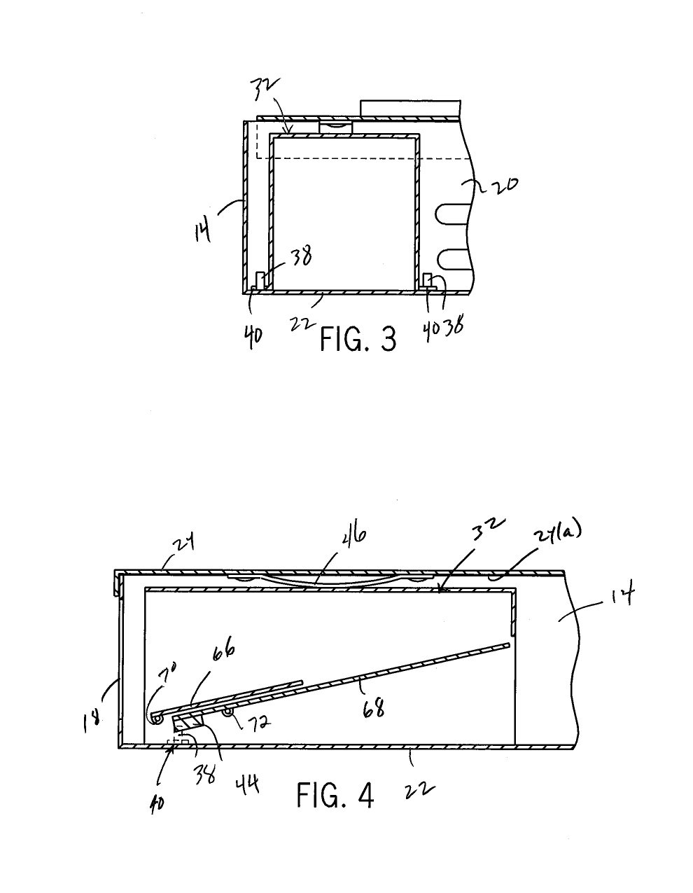

Turning now to FIGS. 1-5, an exemplary repeating animal trap and containment system 10 according to one embodiment of the present invention has a housing 12 defined by a pair of sidewalls 14, 16 and a pair of end walls 18, 20, a bottom panel 22, and an openable cover 24, which collectively define an enlarged containment area, generally shown at 26, for retaining one or more captured rodents. In a preferred embodiment, the cover 24 is coupled to one of the sidewalls, e.g., sidewall 14, by a hinge arrangement 27 that allows the cover 24 to pivot relative to the sidewall 14. Openings 28, 30 are formed in the end walls 18, 20, respectively.

System 10 further has a pair of ramped trapping assemblies 32, 34 removably mounted within the housing. The trapping assemblies 32, 34, which may be of known construction, align with the openings 28, 30 and are designed to allow the ingress of rodents into the housing 12 yet prevent the egress of rodents out of the housing 12. As known in the art, the trapping assemblies 32, 34 communicate with a passageway 36 that allows a rodent that passes through the assemblies 32, 34 to move freely to the containment area 26. The containment area may include food and water for feeding of the trapped rodents until the rodents can be humanely set free. The ramped trapping assemblies 32, 34 however prevent trapped rodents from exiting the housing 12 until a user has removed the cover 24. It will thus be appreciated that the trapping assemblies 32, 34 permit one-way passage of rodents to the containment area 26. In one embodiment, the cover 24 has a window 37 that allows the containment area 26 to be inspected for the presence of a trapped rodent without moving the cover 24 to the open position shown in FIG. 2. It is understood that the window 37 is an optional feature and therefore not required. Moreover, the window 37 may be formed of any known transparent or translucent material, such as glass, thermoplastic, and the like.

With reference also to FIG. 4, the trap assembly 34 has an entrance blockade 66 that is initially held in a lowered position against ramp 68. Blockade 66 may pivot about point 70 and ramp 68 may pivot about point 72. A counterweight 74 is mounted to or otherwise held against the underside of the ramp 68 and is operative to hold the ramp 68 in the lowered position shown in FIG. 4. In this position, the blockade 66 rests against the top of ramp 68. In this lowered position, a rodent may enter the trap assembly 34 through opening 30. As the rodent traverses along the ramp, eventually the weight of the rodent will overwhelm the bias provided by the counterweight and cause the ramp 68 to tilt about the axis defined at pivot point 72. This movement causes the ramp to lower and expose rodent the passageway 36 defined at the opposite end of the trap assembly 34. As the ramp begins to tile or pivot, the pivoting action will cause the blockade 66 to pivot about pivot point 70. This action will cause the blockade to raise and effectively block rodent access out of the trapping assembly 34 through opening 30. Moreover, it will be appreciated that when the ramp and blockade are in the reset position (shown in FIG. 4), the raised ramp prevents a previously trapped rodent from gaining a foothold on the ramp and attempting to escape the trap.

In contrast to conventional repeating animal trapping and containment systems, the trapping assemblies 32, 34 of the present invention are removably secured within the housing. This removability allows the trapping assemblies 32, 34 to be removed from the housing 12 for cleaning and other services needs when required. Of particular advantage is that the removability provided by the present invention allows on-site cleaning of the trapping assemblies. Heretofore, it was generally necessary to transport trapping and containment systems to an offsite location for cleaning.

Accordingly, the present invention provides a set of posts 38 that extend outward from the bottom panel 22. The trapping assemblies 32, 34 have laterally extending flanges, or feet, 40 that are adapted to slide over the posts 36. In this regard, in the illustrated embodiment, each foot 40 has a body 42 formed to have a bore 44, as best shown in FIG. 5. When the trapping assemblies 32, 34 are loaded into the housing 12, as illustrated in FIG. 5, the posts 38 extend through the bores 44. In addition to properly aligning the trapping assemblies 32, 34 with the openings 28, 30, the engagement of the trapping assemblies 32, 34 with the posts 38 prevents lateral displacement of the trapping assemblies 32, 34 within the housing 12 such as may otherwise occur if the system 10 was kicked or otherwise moved.

In addition to preventing lateral displacement of the removable trapping assemblies 32, 34, the present invention further provides a mechanism to prevent vertical displacement of the assemblies 32, 34. In one embodiment, leaf springs 46 are mounted to the underside 24(a) of the cover 24. As the cover 24 is pivoted or lowered to the closed position, the springs 46 engage the top of respective trapping assemblies 32, 34. When the cover 24 is in the full closed position, the springs 46 are compressed by their engagement between the cover 24 and the trapping assemblies 32, 34, which results in the springs 46 applying a down force on the trapping assemblies 32, 34, as best shown in FIG. 4. It will thus be appreciated that the springs 46 allow the trapping assemblies 32, 34 to be pressed snuggly against the bottom panel of the housing without requiring a tight fit between the cover 24 and the trapping assemblies 32, 34. The springs may be integrally formed with the underside of the cover 24 or mounted thereto using suitable fasteners.

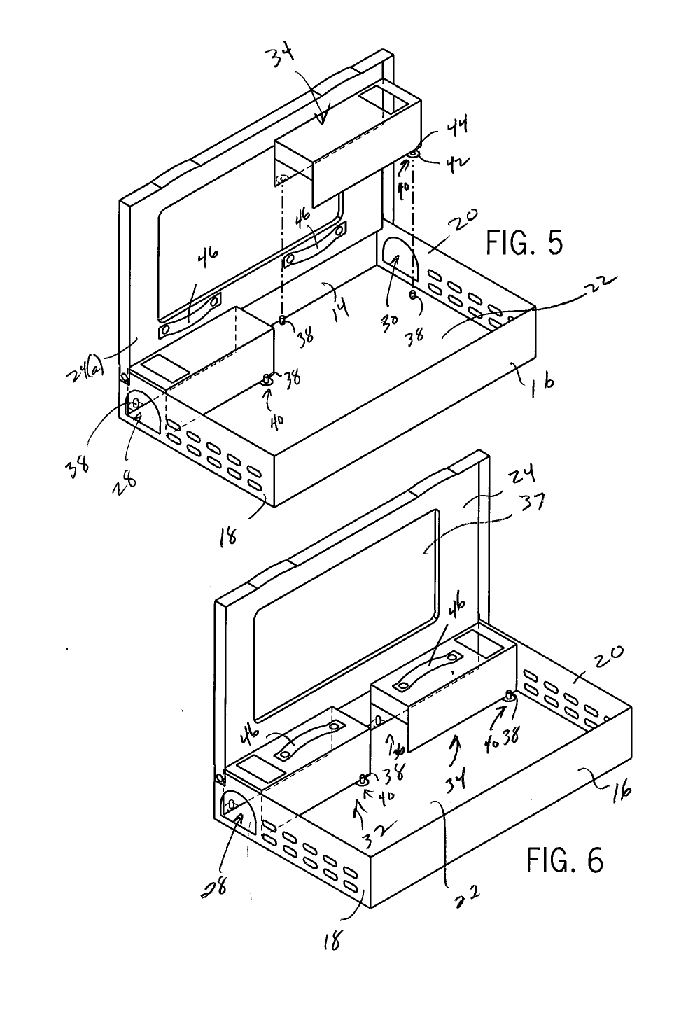

In an alternate embodiment, which is shown in FIG. 6, the springs 46 are formed on or mounted to the top surface of the removable trapping assemblies 32, 34. In addition to providing the down force described above when the cover 24 is lowered into the closed position, having the springs 46 on the top surface of the trapping assemblies 32, 34 allows the springs 46 to also function as handles for lifting and transporting the assemblies 32, 34. The springs 46 may be integrally formed with the trapping assemblies 32, 34 or mounted using suitable fasteners.

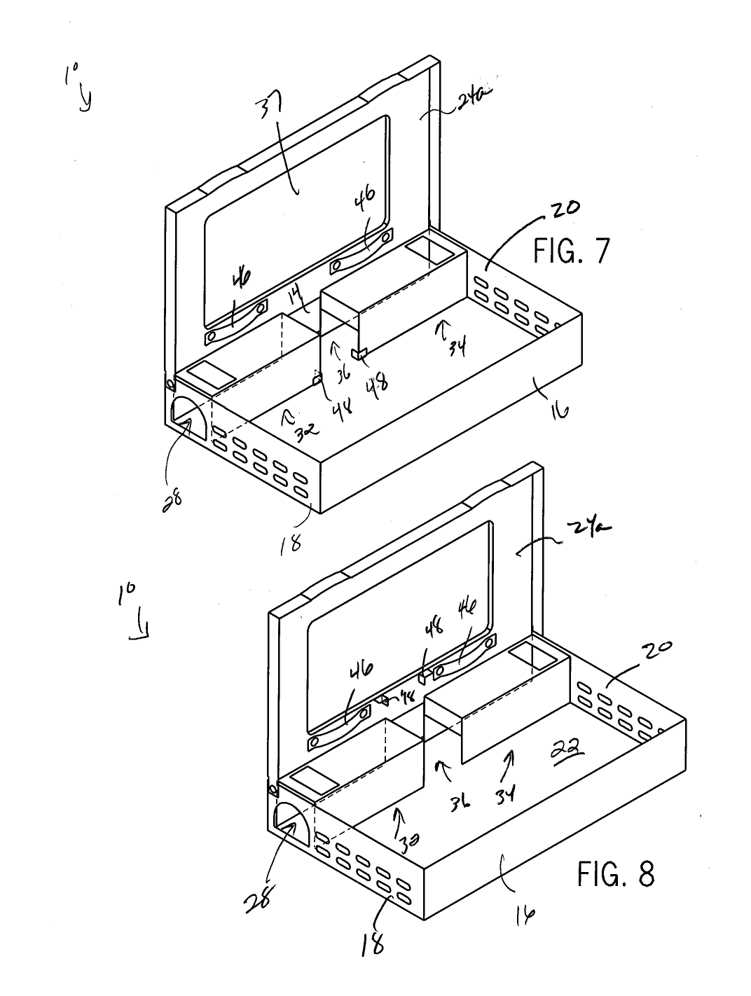

It will be appreciated that other mechanisms can be used to prevent lateral and vertical displacement of the removable trapping assemblies 32, 34 within the housing 12. For example, in one embodiment, which is illustrated in FIG. 7, brackets 48 extend upwardly from the bottom panel 22. The brackets 48, which may be integrally formed with the bottom panel 22 or mounted thereto using brackets or other fastening means, are spaced from sidewall 14 a sufficient distance such that a space is formed between the brackets 48 and the sidewall 14. The trapping assemblies 32, 34 may be drop loaded into the space to provide a relatively snug fit of the trapping assemblies 32, 34 within the housing 12. As best shown in FIG. 7, the orientation of the brackets 48 prevents lateral movement of the trapping assemblies 32, 34 and thus displacement of the trapping assemblies 32, 34 if the system 10 is kicked or otherwise moved. It should be understood that in the embodiment of FIG. 7, the springs 46 could be mounted to the underside of the cover 24 or mounted to the trapping assemblies 32, 34, as described above.

In yet a further alternate embodiment, which is shown in FIG. 8, the brackets 48 extend downward from the underside of the cover 24. In this alternate embodiment, the trapping assemblies 32, 34 are first loaded into the housing at the proper position and when the cover is lowered, the brackets 48 prevent lateral movement of the trapping assemblies 32, 34. It will also be appreciated that for the cover 24 to close properly, the trapping assemblies 32, 34 must be in proper alignment with the openings 28, 30, respectively. If a trapping assembly is misaligned, then a bracket would abut against the top of the trapping assembly which would prevent the cover from being pushed to its fully closed position. It is understood that in the embodiment of FIG. 8, the springs 46 could be mounted to the underside of the cover 24 or mounted to the trapping assemblies 32, 34, as described above.

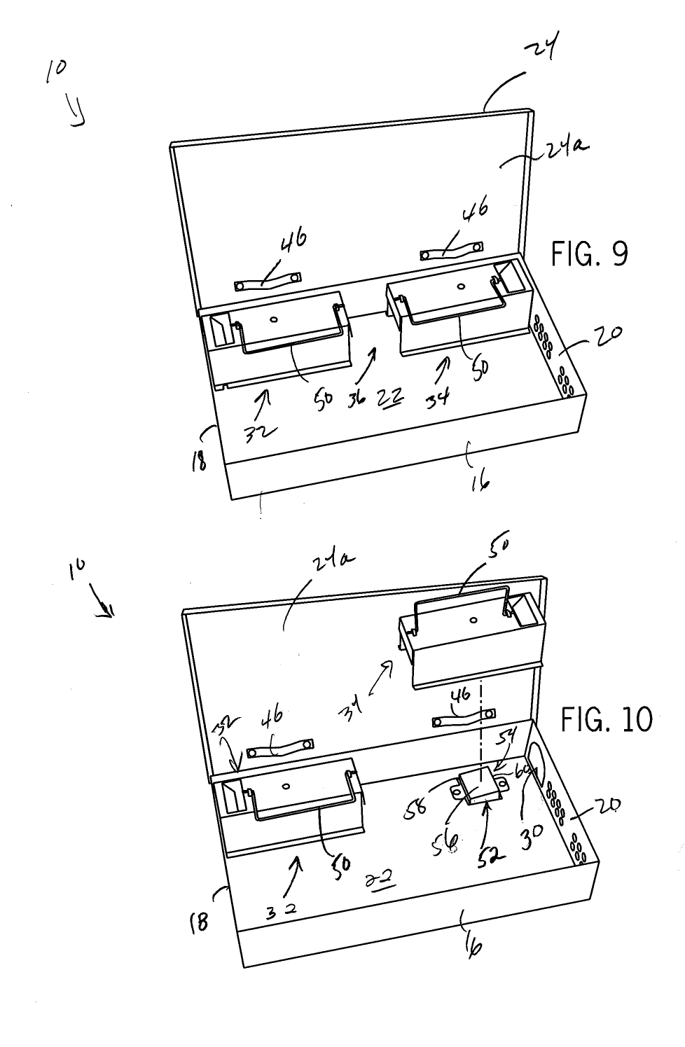

FIGS. 9-11 show another embodiment of the animal trap and containment system 10. In this embodiment, the trapping assemblies 32, 34 are each equipped with a handle 50 that lies flat against the top surface of the trapping assembly when not in use. Thus, the handles 50 do not obstruct closing of the cover when the trapping assemblies are loaded into the housing 12. The handles 50 are free to pivot from the lowered (rest) position shown in FIG. 9 to the raised (in use) position shown in FIG. 10. In this embodiment, it is preferred that the springs 46 that are operative to prevent vertical displacement of the trapping assemblies are mounted to the underside of the cover 24. However, it is contemplated that the springs 46 could be mounted to the top of the trapping assemblies and the handles may be configured to clear the springs 46 when being pivoted to the raised position. The handles 50 may be secured to the trapping assembly in any known manner. Moreover, the invention is not limited to the shape or configuration of the handle shown in FIGS. 9 and 10.

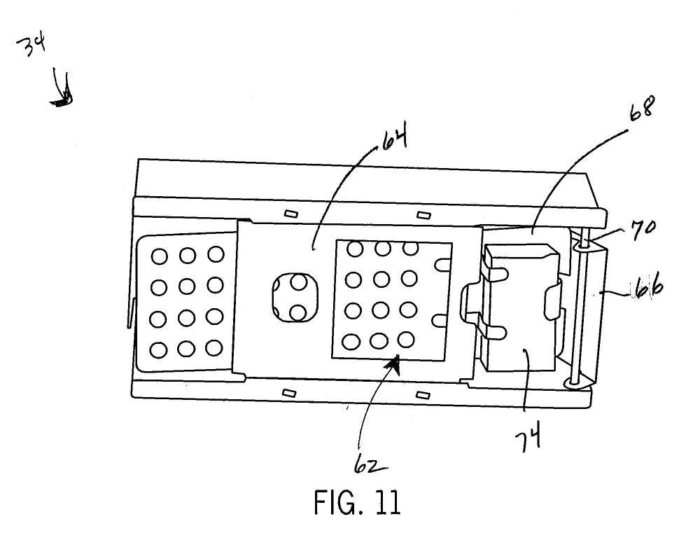

With particular reference to FIGS. 10 and 11, in this embodiment of the invention, an alignment block 52 is fastened to the bottom panel 22. Alternately, the block 52 could be integrally formed with the bottom panel 22. The alignment block 52 generally consists of a body 54 having an inclined face 56 that slopes upward from back wall 58 to front wall 60. The alignment block 52 is oriented so that the face 56 inclines toward the opening 30 in the end wall 20.

The alignment block 52 is received in an opening 62 defined in an alignment plate 64 formed with, or attached to, the bottom of the trap assembly 34, as shown in FIG. 11. As such, when the trap assembly 34 is being loaded into place, for it to properly placed, the opening 62 must be positioned over the alignment block 52 and lowered down.

It should be appreciated that for the trap assembly to work properly, the blockade end of the trap assembly must be positioned at the opening in the end wall of the containment structure. To ensure that the trap assembly is properly placed, the alignment block is positioned and the opening in the alignment plate are likewise positioned such that if the trap assembly was loaded improperly, the ramp would be pivoted to the raised position described above thereby preventing a rodent from entering the trap assembly. Moreover, the opening is preferably off center along the length of the trap assembly and therefore if an attempt was made to load the assembly in a reversed position, the trap assembly would extend over the end wall of the containment structure or housing.

It is understood that while trap assembly 34 has been described, trap assembly 32 is similarly constructed and interfaces with the containment housing, i.e., base panel 22, in a similar manner. Moreover, it is understood that trap assemblies using different types of trapping mechanisms could benefit from at least some of the principles of the present invention.

Various alternatives and embodiments are contemplated as being within the scope of the following claims particularly pointing out and distinctly claiming the subject matter regarded as the invention.

I claim:

1. A repeating animal trap system comprising:
an enclosure defined by a bottom panel, an arrangement of side panels, and a cover, the panels collectively defining an interior volume within the enclosure, wherein one of the side panel include an opening; and
a ramped animal trapping structure removably secured within the enclosure and substantially aligned with the opening in the side panel, the ramped animal trapping structure constructed to allow the ingress of an animal into the interior volume but prevent the egress of an animal from the interior volume of the enclosure.

2. The repeating animal trap system of claim 1 further comprising at least one projection mounted to the enclosure within the interior volume and constructed to limit displacement of the ramped animal trapping structure.

3. The repeating animal trap system of claim 2 wherein the at least one projection includes a post mounted to the bottom panel, and wherein the ramped animal trapping structure includes at least one feature that removably engages the at least one projection to secure the ramped animal trapping structure to the bottom panel.

4. The repeating animal trap system of claim 3 wherein the at least one projection includes a pair of upright posts extending from the bottom panel and wherein the at least one feature includes a pair of feet that engage the posts to restrict lateral movement of the ramped animal trapping structure.

5. The repeating animal trap system of claim 4 wherein the feet are configured to slidably engage the posts without deformation of the ramped animal trapping structure.

6. The repeating animal trap system of claim 1 further comprising a biasing member that allows a down force on the ramped animal trapping structure to hold the ramped animal trapping structure against the bottom panel.

7. The repeating animal trap system of claim 6 wherein the biasing member includes a spring.

8. The repeating animal trap system of claim 7 wherein the spring is mounted to an underside of the cover.

9. The repeating animal trap system of claim 8 wherein the cover is pivotably coupled to one of the side panels, and wherein the spring applies the down force on the ramped animal trapping structure when the cover is pivoted to a closed position.

10. The repeating animal trap system of claim 7 wherein the spring is mounted to a top surface of the ramped animal trapping structure.

11. The repeating animal trap system of claim 10 wherein the spring is further operative as a handle for lifting and carrying the ramped animal trapping structure.

12. The repeating animal trap system of claim 1 comprising the first-mentioned ramped animal trapping structure and a second ramped animal trapping structure removably secured to the bottom panel of the enclosure.

13. An animal containment apparatus comprising:
a housing having an animal containment area;
a repeating animal trap removably mounted within the housing and configured to permit the ingress of an animal to the animal containment area but prevent the egress of an animal from the animal containment area; and
means for restricting lateral displacement of the repeating animal trap within housing.

14. The animal containment apparatus of claim 13 wherein the restricting means includes at least one upright member mounted to a bottom panel of the housing.

15. The animal containment apparatus of claim 14 wherein the animal trap is removably secured in the housing between the at least one upright member and an outer wall of the housing.

16. The animal containment apparatus of claim 14 wherein the at least one upright members includes a pair of posts and wherein the animal trap has a pair of feet adapted to engage the pair of posts.

17. The animal containment apparatus of claim 13 further comprising means for restricting vertical displacement of the repeating animal trap within the housing.

18. The animal containment apparatus of claim 17 wherein the means for restricting vertical displacement includes a spring mounted to one of the housing and the repeating animal trap.

19. An animal containment apparatus comprising:
a housing having an animal containment area;
a repeating animal trap removably mounted within the housing and configured to permit the ingress of an animal to the animal containment area but prevent the egress of an animal from the animal containment area; and
means for restricting vertical displacement of the repeating animal trap within the housing.

20. The animal containment apparatus of claim 19 wherein the restricting means includes a spring, wherein the spring is attached to an underside of a cover of the housing.
